(19) United States
(12) Patent Application Publication
(10) Pub. No.: US 2023/0368542 A1
(43) Pub. Date: Nov. 16, 2023

(54) OBJECT TRACKING DEVICE, OBJECT TRACKING METHOD, AND RECORDING MEDIUM

(71) Applicant: NEC Corporation, Minato-ku, Tokyo (JP)

(72) Inventor: Takuya OGAWA, Tokyo (JP)

(73) Assignee: NEC Corporation 7-1, Shita-5-chome, Minato-ku, Tokyo (JP)

(21) Appl. No.: 18/033,196

(22) PCT Filed: Oct. 30, 2020
(86) PCT No.: PCT/JP2020/040791

§ 371 Date: Apr. 21, 2023

(51) Int. Cl. G06V 20/58; G06V 10/62; G06V 10/22; G06V 10/82

(52) U.S. Cl. CPC G06V 20/58; G06V 10/22; G06V 10/62; G06V 10/82; G06V 2201/07

(57) ABSTRACT

In an object tracking device, an extraction means extracts target candidates from time series images. A search range update means updates a search range based on frame information of a target in a previous image in a time series and a movement pattern of the target. A tracking means searches for and tracks the target using a confidence level indicating similarity with a target model among the target candidates. A model update means updates the target model using the target candidates extracted in the search range.

### TECHNICAL FIELD

The present disclosure relates to a technique for tracking each object in an image.

### BACKGROUND ART

An object tracking method is known to detect a specific object in a video image as a target, and to track a movement of a target in an image. In object tracking, features of the target in the image are extracted and each object with similar features is tracked as the target.

Patent document 1 describes an object tracking method which takes into account overlapping of objects. In addition, Patent Document 2 describes a method for predicting a position of each object in a current frame based on a tracking result of a previous frame, and for determining a search range of the object from the predicted position.

### PRECEDING TECHNICAL REFERENCES

### Patent Document

Patent Document 1: Japanese Laid-open Patent Publication No. 2018-112890
Patent Document 2: Japanese Laid-open Patent Publication No. 2016-071830

### SUMMARY

### Problem to Be Solved by the Invention

One problem in an object tracking technology is a phenomenon known as “passing over”. This refers to a phenomenon in which, when an object similar to a target appears while the target is being tracked and passes by or blocks the target, an object tracking device subsequently erroneously discriminates and tracks the similar object as the target. Once the passing over occurs, it becomes very difficult to return to the correct target because the object tracking device subsequently learns features of the similar object and continues to track the similar object.

It is one object of the present disclosure to prevent the passing over in the object tracking device.

### Means for Solving the Problem

According to an example aspect of the present disclosure, there is provided an object tracking device including:
an extraction means configured to extract target candidates from time series images;
a search range update means configured to update a search range based on frame information of a target in a previous image in a time series and a movement pattern of the target;
a tracking means configured to search for and track the target using a confidence level indicating similarity with a target model among the target candidates extracted in the search range; and
a model update means configured to update the target model using the target candidates extracted in the search range.

According to another example aspect of the present disclosure, there is provided a n object tracking method including:
extracting target candidates from time series images;
updating a search range based on frame information of a target in a previous image in a time series and a movement pattern of the target;
searching for and tracking the target using a confidence level indicating similarity with a target model among the target candidates extracted in the search range; and
updating the target model using the target candidates extracted in the search range.

According to a further example aspect of the present disclosure, there is provided a recording medium storing a program, the program causing a computer to perform a process including:
extracting target candidates from time series images;
updating a search range based on frame information of a target in a previous image in a time series and a movement pattern of the target;
searching for and tracking the target using a confidence level indicating similarity with a target model among the target candidates extracted in the search range; and
updating the target model using the target candidates extracted in the search range.

### BRIEF DESCRIPTION OF THE DRAWINGS

FIG. 1 is a block diagram illustrating an overall configuration of an object tracking device according to a first example embodiment.

FIG. 2 is a block diagram illustrating a hardware configuration of the object tracking device according to the first example embodiment.

FIG. 3 is a block diagram illustrating a functional configuration of the object tracking device according to the first example embodiment.

FIG. 4 is a block diagram illustrating a configuration of a preliminary training unit.

FIG. 5 is a block diagram illustrating a configuration of a target model generation unit.

FIG. 6 illustrates an example of a category/movement pattern correspondence table.

FIG. 7 is a block diagram illustrating a configuration of a tracking unit.

FIG. 8 illustrates a setting method of a target search range.

FIG. 9 illustrates an example of a template of a search range.

FIG. 10 illustrates an example of modifying a target search range.

FIG. 11 is a flowchart of a preliminary training process according to the first example embodiment.

FIG. 12 is a flowchart of a target model generation process according to the first example embodiment.

FIG. 13 is a flowchart of a tracking process according to the first example embodiment.

FIG. 14 is a flowchart of a search range update process according to the first example embodiment.

FIG. 15 is a block diagram illustrating a configuration of a preliminary training unit according to a second example embodiment.

FIG. 16 is a block diagram illustrating a configuration of a target model generation unit according to the second example embodiment.

FIG. 17 is a flowchart of a preliminary training process according to the second example embodiment.

FIG. 18 is a flowchart of a target model generation process according to the second example embodiment.

FIG. 19 is a block diagram illustrating a functional configuration of an object tracking device according to a second example embodiment.

FIG. 20 is a flowchart of an object tracking process according to a second example embodiment.

### EXAMPLE EMBODIMENTS

In the following, example embodiments will be described with reference to the accompanying drawings.

### First Example Embodiment

### [Overall Configuration of an Object Tracking Device]

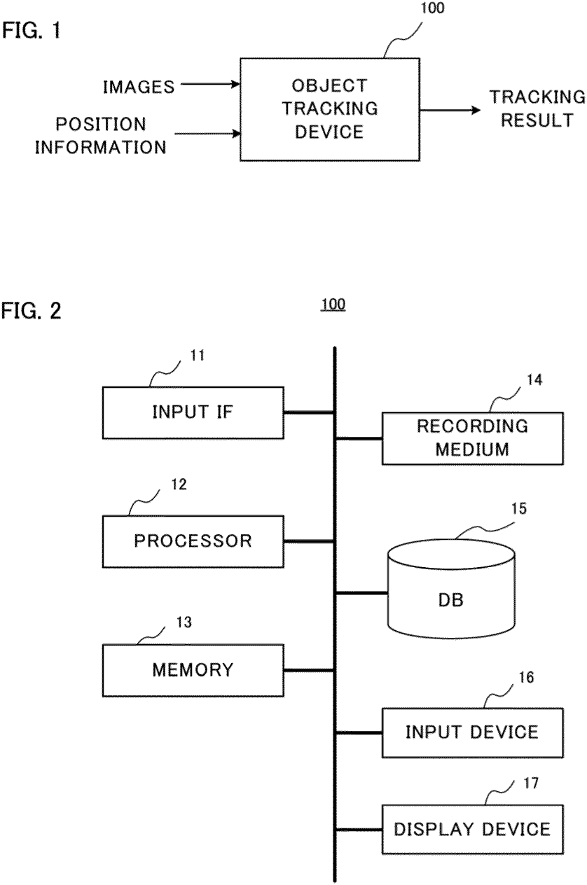

FIG. 1 illustrates an overall configuration of an object tracking device of a first example embodiment. An image including an object to be tracked (called a “target”) and position information indicating a position of the target in the image are input to an object tracking device 100. Note that the input image is a video image obtained from a camera or a database, that is, a time series image (continuous image sequence) that forms a video. The object tracking device 100 generates a target model which indicates characteristics of the target specified by a position in the input image, and detects and tracks each object similar to the target model as the target in each frame image. The object tracking device 100 generates a frame that encompasses the target in the input image (hereinafter referred to as “target frame”). The object tracking device 100 outputs, as tracking results, frame information indicating a position and a size of each frame (hereinafter referred to as a “target frame”) in the input image and an image displaying the target frame on an original video image.

### [Hardware Configuration]

FIG. 2 is a block diagram illustrating a hardware configuration of the object tracking device 100 of the first example embodiment. As illustrated in the FIG. 2, the object tracking device 100 includes an input IF (InterFace) 11, at least one processor 12, a memory 13, a recording medium 14, a database (DB) 15, an input device 16, and a display device 17.

The input IF 11 inputs and outputs data. Specifically, the input IF 11 acquires an image including the target and also acquires the position information indicating an initial position of the target in the image.

The processor 12 is a computer such as a central processing unit (CPU) or graphics processing unit (GPU), which controls the entire object tracking device 100 by executing programs prepared in advance. In particular, the processor 12 performs a preliminary training process, a target model generation process, and a tracking process described below.

The memory 13 is formed by a ROM (Read Only Memory), a RAM (Random Access Memory), and the like. The memory 13 stores various programs executed by the processor 12. The memory 13 is also used as a working memory during executions of various processes by the processor 12.

The recording medium 14 is a nonvolatile and non-transitory recording medium, such as a disk-shaped recording medium or a semiconductor memory, and is removable from the object tracking device 100. The recording medium 14 records various programs to be executed by the processor 12.

The DB 15 stores data input from the input IF 11. Specifically, the DB 15 stores images including the target. In addition, the DB 15 stores information such as the target model used in object tracking.

The input device 16 is, for instance, a keyboard, a mouse, a touch panel, or the like, and is used by a user to provide necessary instructions and inputs related to processes by the object tracking device 100. The display device 17 is, for instance, a liquid crystal display, or the like, and is used to display images illustrating the tracking results or the like.

### [Functional Configuration]

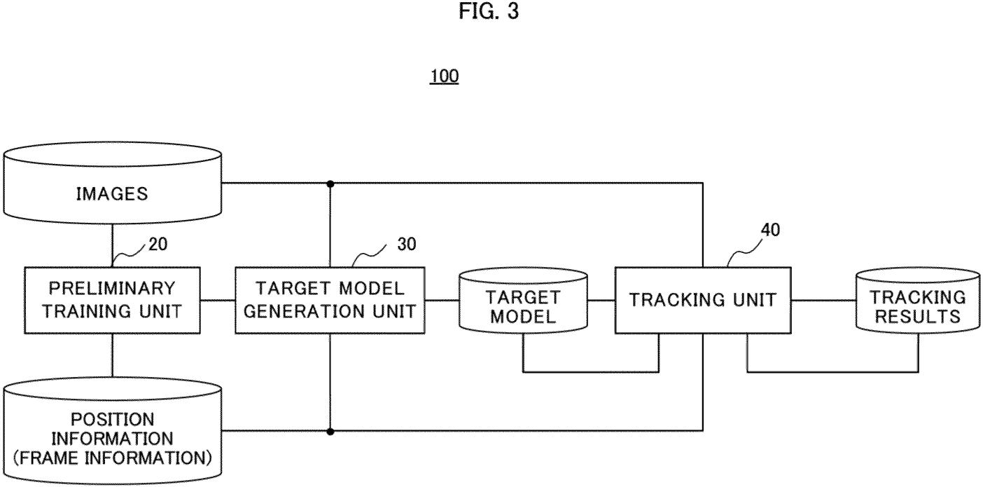

FIG. 3 is a block diagram illustrating a functional configuration of the object tracking device 100 of the first example embodiment. The object tracking device 100 includes a preliminary training unit 20, a target model generation unit 30, and a tracking unit 40. The preliminary training unit 20 generates a tracking feature model based on the input image and the position information of the target in the input image, and outputs the tracking feature model to the target model generation unit 30. The preliminary training unit 20 also generates a category discrimination model to discriminate a category of the target in the input image, and outputs the tracking feature model to the target model generation unit 30.

The target model generation unit 30 generates a target model indicating the characteristics of the target based on the input image, the position information of the target in the image, and the tracking feature model, and outputs the target model to the tracking unit 40. The tracking unit 40 detects and tracks the target from the input image using the target model, and outputs the tracking results. The tracking unit 40 also updates the target model based on the detected target. Each of elements is described in detail below.

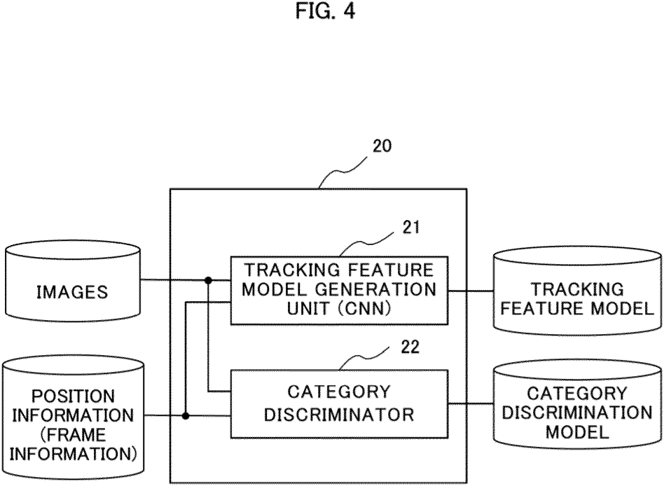

FIG. 4 illustrates a configuration of the preliminary training unit 20. The preliminary training unit 20 performs preliminary training of the tracking feature model and the category discriminant model. In detail, the preliminary training unit 20 includes a tracking feature model generation unit 21 and a category discriminator 22. The tracking feature model generation unit 21 trains the tracking feature model and generates the trained tracking feature model. The “tracking feature model” is a model in which features to be focused on in tracking the target are trained in advance. The tracking feature model generation unit 21 is formed by a feature extractor such as a CNN (Convolutional Neural Network) or the like. The tracking feature model generation unit 21 trains basic features of the object to be the target, and generates the tracking feature model. For instance, in a case where the target to be tracked is a “specific person,” the tracking feature model generation unit 21 trains features of a general “person (human)” using each input image.

In the above example, the position information indicating the position of the person in the image is input to the tracking feature model generation unit 21 along with the input image. The position information of an area of the person is input, for instance, by the user who specifies a frame which encompasses the person in the image displayed on the display device 17 by operating the input device 16. Alternatively, an object detector which detects the person from the input image may be provided in a previous stage, and the position of the person detected by the object detector may be input to the tracking feature model generation unit 21 as the position information. The tracking feature model generation unit 21 trains the tracking feature model by assuming that an object in the area indicated by the above position information in the input image is a positive example (“person”) and other objects are negative examples (“non-persons”), and outputs the trained tracking feature model.

Note that in the above example, the tracking feature model is trained using deep learning with the CNN, but other types of feature extraction methods may be used to generate the tracking feature model. At a time of generating the tracking feature model, not only the same object in images at consecutive times (that is, time t and time t+1) but also the same object in images at more distant times (that is, time t and time t+10) may be used for learning. Accordingly, it is possible to accurately extract the target even in a case where an appearance of the object has been significantly deformed. Moreover, the position information input to the preliminary training unit 20 may be a center position of the target, target segmentation information of the target, or the like, other than the frame which encompasses the target as described above.

The category discriminator 22 generates a category discrimination model which determines a category of the target in the input image. The category discriminator 22 is formed, for instance, by using the CNN. The category discriminator 22 determines the category of the target based on the input image and the position information indicating the position of the target in the image. Each target is classified in advance into one of several categories, that is, a “person,” a “bicycle,” a “car,” and so on. The category discriminator 22 trains the category discrimination model to discriminate the category of the target from the input image using the input image for training and training data, and outputs the trained category discrimination model. That is, the target may be classified into a more detailed category, for instance, a “car type” for the “car”. In this case, the category discrimination model is trained to be able to discriminate a type of the car, or the like.

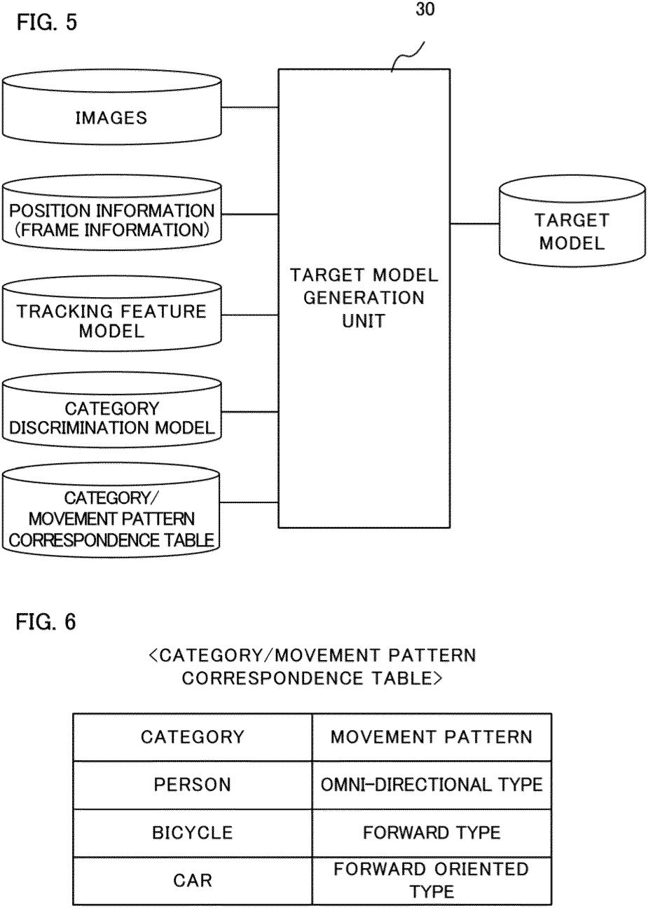

FIG. 5 illustrates a configuration of the target model generation unit 30. The target model generation unit 30 generates a target model by updating the tracking feature model using image features of the target in the input image. A video image including a plurality of frame images is input to the target model generation unit 30 as the input image. The frame information of the target in the above input image is also input to the target model generation unit 30. Note that the frame information is information indicating the size and position of the target frame which encompasses the target. Moreover, the tracking feature model and the category discrimination model generated by the preliminary training unit 20 are input to the target model generation unit 30. Furthermore, the target model generation unit 30 can refer to a category/movement pattern correspondence table.

The target model is a model which indicates the image features to be focused on for tracking the target. Here, the aforementioned tracking feature model is a model which indicates the basic features of an object to be targeted, whereas the target model is a model which indicates the individual features of an object to be tracked. For instance, in a case where the target of tracking is a “specific person”, the target model is a model which indicates the features of the specific person designated by the user in the input image. That is, the generated target model also includes features specific to the specific person designated by the user in the input image.

The target model generation unit 30 includes a feature extractor such as the CNN, and extracts image features of the target from an area of the target frame in the input image. Next, the target model generation unit 30 uses the extracted image features of the target and the tracking feature model to generate a target model which indicates the features to be focused on for tracking that specific target. In addition to the image features of the tracking feature model, the target model also includes information such as the size and an aspect ratio of the target, and movement information including a movement direction, a movement amount, and a movement speed of the target.

Moreover, the target model generation unit 30 estimates a movement pattern of the target using the category discrimination model, and adds the movement pattern to the target model. In detail, the target model generation unit 30 first determines the category of the input image using the category discrimination model. Next, the target model generation unit 30 refers to the category/movement pattern correspondence table, and derives the movement pattern for the discriminated category.

The “movement pattern” indicates a type of a movement of the target based on a probability distribution of the movement direction of the target. Specifically, the movement pattern is defined by the combination of the movement direction of the target and the probability of moving in that direction. For instance, in a case where the target moves in any direction from a current position with almost the same probability, the movement pattern is an “omni-directional type”. In a case where the target moves only forward from the current position, the movement pattern is a “forward type”. In a case where the target moves forward with high probability from the current position but may also move backward, the movement pattern is a “forward oriented type”. In reality, the movement direction of the target can be a backward direction, a rightward direction, a leftward direction, a right diagonal forward direction, a left diagonal forward direction, a right diagonal backward direction, a left diagonal backward direction, and various other directions in addition to the forward direction. Therefore, the movement pattern can be specified as an “XX direction type”, an “XX oriented type”, or the like, depending on the direction of the movement of the target and the probability of the movement in that direction. In a case where the target moves only in one of a plurality of directions, for instance, in a case where the target moves only either a forward right or a backward left, the movement pattern may be defined as a “forward right/backward left type,” or the like.

FIG. 6 illustrates an example of the category/movement pattern correspondence table. The category/movement pattern correspondence table specifies, for each category, the movement pattern of each of objects in that category when the objects move. For instance, the movement pattern of the “person” is defined as the “omni-directional type” because the person is basically free to move back and forth, left and right. The “bicycle” basically moves only forward, so the movement pattern is defined as the “forward type”. The “car” can move backward as well as forward, but since the “car” is more likely to move forward, the movement pattern is defined as the “forward oriented type”.

The target model generation unit 30 refers to the category/movement pattern correspondence table, derives the movement pattern of the target from the category of the target in the input image, and adds the movement pattern to the target model. After that, the target model generation unit 30 outputs the generated target model to the tracking unit 40.

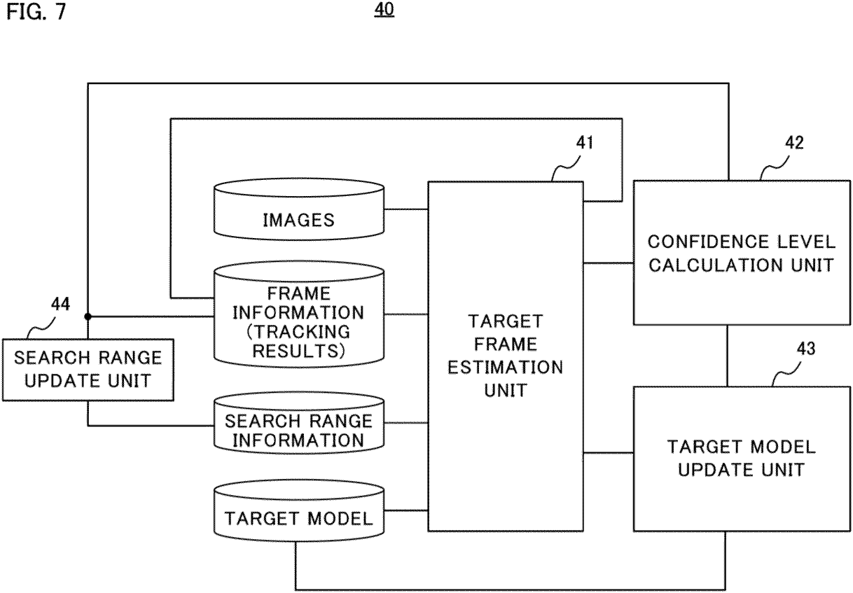

FIG. 7 is a block diagram illustrating a configuration of the tracking unit 40. The tracking unit 40 detects and tracks the target from input images, and updates the target model using information of the object obtained during a target detection. The tracking unit 40 has a target frame estimation unit 41, a confidence level calculation unit 42, a target model update unit 43, and a search range update unit 44.

First, the frame information is input to the search range update unit 44. This frame information includes the frame information of the target obtained as a result of tracking and a confidence level of the frame information, in a previous frame image. Note that initial frame information is input by the user. That is, when the user designates the position of the target in the input image, the position information is used as the frame information, and the confidence level is set to “1” at that time. First, the search range update unit 44 sets the target search range (also simply called a “search range”) based on the input frame information. The target search range is set based on the frame information input. The target search range is the range in which the target is expected to be included in that frame image, and is set centered on the target frame in the previous frame image.

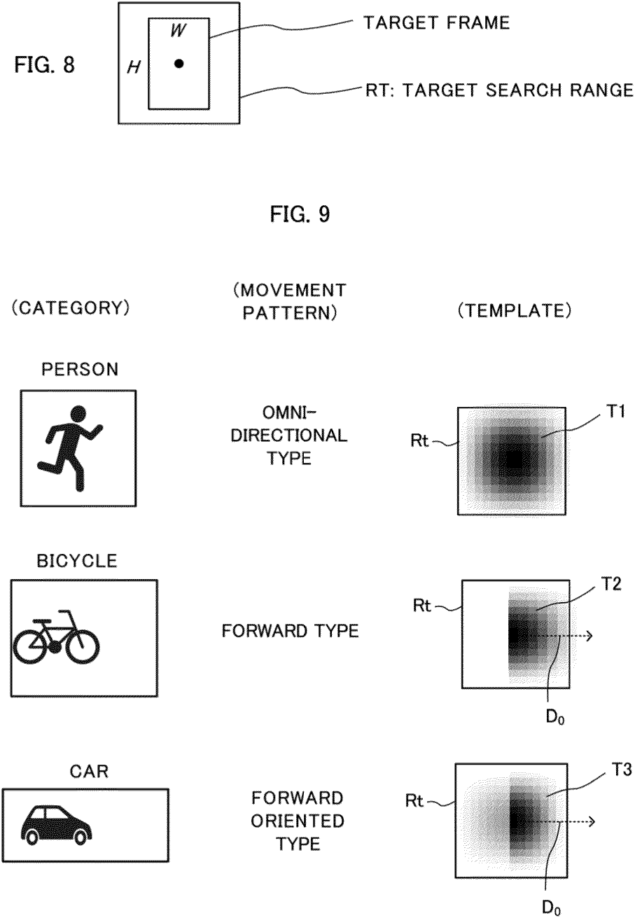

FIG. 8 illustrates a setting method of the target search range. In an example in FIG. 8, the frame information of the target frame, which is a rectangle of height H and width W, is input to the search range update unit 44. The search range update unit 44 first sets the target search range to the area which encompasses the target frame indicated by the input frame information.

Next, the search range update unit 44 determines a template to be applied to the target search range according to the movement pattern of the target. The movement pattern of the target is included in the target model as described above. Accordingly, the search range update unit 44 determines the template for the search range based on the movement patterns included in the target model, and applies the template to the target search range.

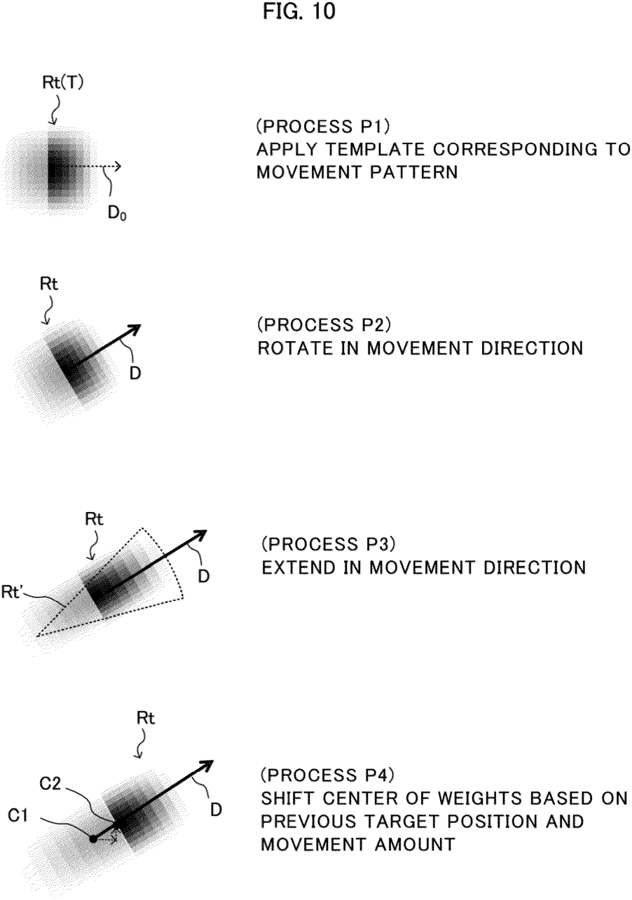

FIG. 9 illustrates an example of the search range template (hereafter simply referred to as a “template”). For instance, in a case where the object category is the “human”, the movement pattern is the “omni-directional type” as described above, and the target model indicates the movement pattern “omni-directional type”. Therefore, the search range update unit 44 selects a template T1 corresponding to the omni-directional type. Similarly, the search range update unit 44 selects a template T2 in a case where the target model indicates the movement pattern “forward type”, and the search range update unit 44 selects a template T3 in a case where the target model indicates the movement pattern “forward oriented type”.

Each of the templates T1 to T3 is formed by a distribution of weights according to positions in the template. In an example in FIG. 9, the closer the color illustrated in a grayscale is to black, the greater the weight, and the closer to white, the smaller the weight. Each weight corresponds to a probability of a target presence, and each template is created on an assumption that a position with a higher weight has a higher probability of the target presence.

In the example in FIG. 9, in the template T1, which corresponds to the movement pattern “omni-directional type”, because the existence probability of the target is equal in all directions, the weights are larger closer to a center of the template T1 and smaller away from the center in all directions. In the template T2, which corresponds to the movement pattern “forward oriented type”, because the existence probability of the target is high in the forward direction of the movement and close to zero in a backward direction, the weights are distributed only in the forward direction of movement. In the template T3, which corresponds to the movement pattern “forward oriented type”, because the existence probability of the target at a next time is high in the forward direction of the movement and low in the backward direction, the weights are greater in the forward direction of the movement and smaller in the backward direction of the movement. Note that a reference direction is defined for templates with directional distribution of weights, such as the forward type and the forward oriented type. In the example in FIG. 9, a reference direction D₀ illustrated by dashed arrows is specified for the templates T2 and T3 corresponding to respective movement patterns of the forward type and the forward oriented type.

The search range update unit 44 first applies the template determined based on the movement pattern of the target to a target search range Rt which is determined based on the input frame information, as illustrated in FIG. 9. Next, the search range update unit 44 modifies the target search range Rt to which the template is applied, using the movement information such as a direction, speed, and a movement amount of the target.

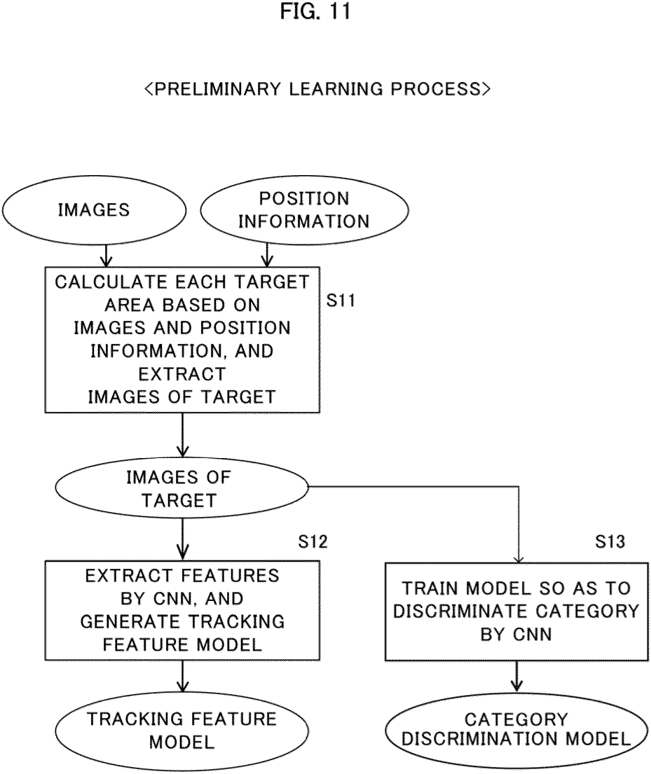

FIG. 10 illustrates an example of modifying the target search range. FIG. 10 is an example using the template T3 of the forward oriented type depicted in FIG. 9. First, the search range update unit 44 applies the template T3 determined based on the movement patterns included in the target model to the target search range Rt as described above (process P1). As a result, the target search range Rt is initially set to the range indicated by the weight distribution of the template T3. Next, the search range update unit 44 rotates the target search range Rt in the movement direction of the target (process P2). Specifically, the search range update unit 44 rotates the target search range Rt so that the reference direction D₀ of the template T3 applied to the target search range Rt matches a movement direction D of the target.

Next, the search range update unit 44 extends the target search range Rt in the movement direction of the target (process P3). For instance, the search range update unit 44 extends the target search range Rt in the movement direction D in proportion to a moving speed (number of moving pixels or frames) of the target on the image. Furthermore, the search range update unit 44 may contract the target search range Rt in a direction orthogonal to the movement direction D. As a result, the target search range Rt becomes an elongated shape in the movement direction D of the target. Alternatively, as depicted by a dashed line Rt′ in FIG. 10, the search range update unit 44 may transform the target search range Rt into a shape which is wider on a forward side in the movement direction D of the target and narrower on a rear side in the movement direction D of the target, such as a fan shape.

Furthermore, the search range update unit 44 moves the center of weights in the target search range Rt in the movement direction D of the target based on the most recent movement amount of the target (process P4). In detail, as depicted in FIG. 10, the search range update unit 44 moves a current center C1 of the weights in the target search range Rt to a predicted position C2 of the target in a next frame.

As described above, the search range update unit 44 first applies the template determined based on the movement pattern of the target to the target search range Rt, and then modifies the target search range Rt based on the movement information of the target. Accordingly, it is possible for the target search range Rt to be constantly updated to an appropriate range in consideration of the movement characteristics of the target.

In the above example, all of the processes P1 to P4 are performed to determine the target search range Rt, but this is not required. For instance, the search range update unit 44 may perform only the process P1, or may perform one or two of the processes P2 to P4 in addition to the process P1. In the above example, the templates T1 to T3 corresponding to the movement pattern have weights corresponding to their positions, but templates without weights, that is, templates with uniform weights for the entire area, may be used. In that case, the search range update unit 44 does not perform the process P4.

Once the target search range Rt is thus determined, the tracking unit 40 detects and tracks each target from the input image. First, the target frame estimation unit 41 estimates each target frame using the target model within the target search range Rt of the input image. In detail, the target frame estimation unit 41 extracts a plurality of tracking candidate windows belonging to the target search range Rt centered on the target frame. For instance, an RP (Region Proposal) obtained using an RPN (Region Proposal Network) or the like can be used as a tracking candidate window. Each tracking candidate window is an example of a target candidate. The confidence level calculation unit 42 compares the image features of each tracking candidate window multiplied by the weights in the target search range Rt with the target model to calculate the confidence level of each tracking candidate window. The “confidence level” is a degree of similarity with the target model. Then, the target frame estimation unit 41 determines the tracking candidate window with the highest confidence level among each tracking candidate window as the result of tracking in that image, that is, the target. This target frame information, that is, the target frame, is used in the process of the next frame image.

The target model update unit 43 determines whether the confidence level of the target frame thus obtained belongs to a predetermined value range, and the target model is updated using the tracking candidate window when the confidence level belongs to the predetermined value range. Specifically, the target model update unit 43 updates the target model by multiplying the target model by the image feature map obtained from the tracking candidate window. Note that when the confidence level of the target frame does not belong to the predetermined value range, the target model update unit 43 does not update the target model using that tracking candidate window.

In the above configuration, the target frame estimation unit 41 corresponds to examples of an extraction the and a tracking means, the search range update unit 44 corresponds to an example of search range update means, and the target model update unit 43 corresponds to an example of model update means.

### [Processes by the Object Tracking Device]

Next, each process performed by the object tracking device 100 will be described. The object tracking device 100 executes a preliminary training process, a target model generation process, and a tracking process. In the following, the processes are described in turn.

### (Preliminary Training Process)

The preliminary training process is executed by the preliminary training unit 20 to generate the tracking feature model and the category discrimination model based on the input image and the target position information. FIG. 11 is a flowchart of the preliminary training process. This process is realized by the processor 12 illustrated in FIG. 2 which executes a program prepared in advance. Note that in the preliminary training process, the tracking feature model and the category discrimination model are generated using the training data prepared in advance.

First, the tracking feature model generation unit 21 calculates the target area in each input image based on the input image and the position information of the target in each input image, and extracts images of the target (step S11). Next, the tracking feature model generation unit 21 extracts features from the images of the target using the CNN, and generates the tracking feature model (step S12). Accordingly, the tracking feature model representing the features of the target is generated.

The category discriminator 22 trains to discriminate the category of the target from the image of the target extracted in step S11 by the CNN, and generates the category discrimination model (step S13). After that, the preliminary training process is terminated.

In the preliminary training process, in order to track the same target by the tracking unit 40, the tracking feature model is generated assuming that targets in the time series images are identical. In addition, in order to prevent the passing over, the tracking feature models are generated for the target and others as different. In addition, in order to recognize objects with more detailed image features, tracking feature models are generated for different types of objects in the same category, such as a motorcycle and the bicycle, or the same object in different colors, as different objects.

### (Target Model Generation Process)

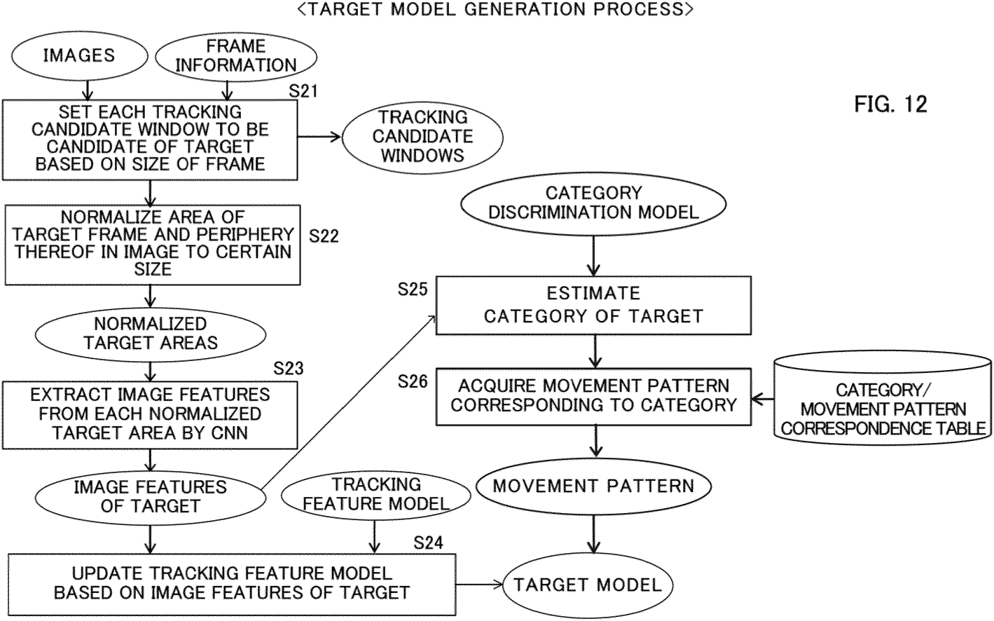

Following the preliminary training process, the target model generation process is executed. The target model generation process is executed by the target model generation unit 30, and generates the target model using the input image, the target frame information in the input image, the tracking feature model, the category discrimination model, and the category/movement pattern correspondence table. FIG. 12 is a flowchart of the target model generation process. This target model generation process is realized by the processor 12 illustrated in FIG. 2, which executes a program prepared in advance.

First, the target model generation unit 30 sets tracking candidate windows which indicate target candidates based on the size of the frame indicated by the frame information (step S21). Each tracking candidate window is a window used to search for the target in the tracking process described below, and is set to the same size as the size of the target frame indicated by the frame information.

Next, the target model generation unit 30 normalizes an area of the target frame and a periphery of the target frame in the input image to a certain size, and generates a normalized target area (step S22). This is a pre-processing step for the CNN to adjust the area of the target frame to a size suitable for an input of the CNN. Next, the target model generation unit 30 extracts image features from the normalized target area using the CNN (step S23).

Next, the target model generation unit 30 updates the tracking feature model generated by the preliminary training unit 20 with the image features of the target, and generates the target model (step S24). In this example, image features are extracted from the target area indicated by the target frame using the CNN, but another method may be used to extract image features. The target model may also be represented by one or more feature spaces, for instance, by feature extraction using the CNN. As described above, in addition to the image features of the tracking feature model, the target model also retains information such as the size and aspect ratio of the target, as well as the movement information including the movement direction, the movement amount, the movement speed, and the like of the target.

The target model generation unit 30 determines the category of the target from the image features of the target extracted in step S23, using the category discrimination model generated by the preliminary training unit 20 (step S25). Next, the target model generation unit 30 refers to the category/movement pattern, derives the movement pattern corresponding to that category, and adds the movement pattern to the target model (step S26). Thus, the target model includes the movement pattern of the target. The target model generation process is then terminated.

### (Tracking Process)

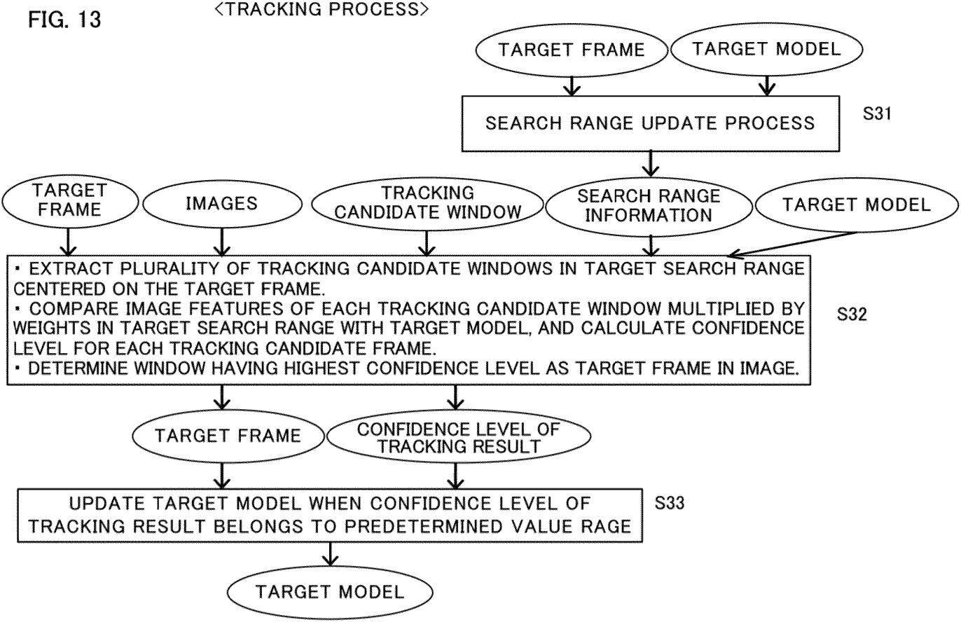

Following the target model generation process, the tracking process is executed. The tracking process is executed by the tracking unit 40 to track the target in the input image and to update the target model. FIG. 13 is a flowchart of the tracking process. This tracking process is realized by the processor 12 illustrated in FIG. 2, which executes a program prepared in advance and operates as each of the elements depicted in FIG. 7.

First, the search range update unit 44 executes a search range update process (step S31). The search range update process updates the target search range based on the target frame in the previous frame image. The target frame in the previous frame image is generated in the tracking process described below.

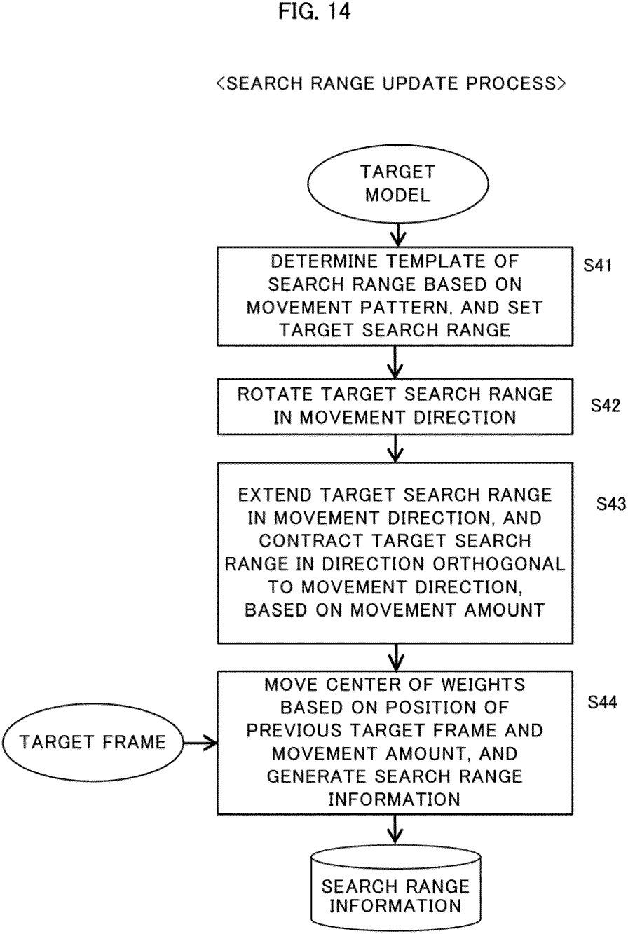

FIG. 14 is a flowchart of the search range update process. At the beginning of the search range update process, the position of the target being input in the preliminary training process is used as the target frame, and “1” is used as the confidence level of the target frame.

First, the search range update unit 44 determines a template for the search range based on the movement pattern of the target indicated by the target model, and sets the template as the target search range Rt (step S41). In detail, the search range update unit 44 determines a corresponding template based on the movement pattern of the target, and applies the corresponding template to the target search range Rt, as depicted in FIG. 9. This process corresponds to the process P1 depicted in FIG. 10.

After the target search range Rt is thus set, the search range update unit 44 modifies the target search range Rt based on the direction and the movement amount of the target. In detail, first, the search range update unit 44 rotates the target search range Rt in the direction of target movement based on the direction of target movement indicated by the target model (step S42). This process corresponds to the process P2 depicted in FIG. 10.

Next, the search range update unit 44 extends the target search range Rt in the movement direction of the target, and contracts the target search range Rt in the direction orthogonal to the movement direction of the target, based on the movement direction of the target indicated by the target model (step S43). This process corresponds to the process P3 depicted in FIG. 10. At this time, the target search range Rt may be contracted in a direction opposite to the movement direction of the target as described above, and the target search range Rt may be shaped like a fan.

Next, the search range update unit 44 moves the center of the weights in the target search range Rt based on the position of the target frame in the previous frame image and the amount of target movement. This process corresponds to the process P4 illustrated in FIG. 10. Next, the search range update unit 44 generates search range information indicating the target search range Rt (step S44), and terminates the search range update process.

As described above, in the search range update process, the target search range Rt is set using the template determined according to the target movement pattern, and the target search range Rt is further modified based on the movement direction and the movement amount of the target. Therefore, it is possible to constantly update the target search range Rt to be an appropriate range according to the movement characteristics of the target.

Next, the process returns to FIG. 13, and the target frame estimation unit 41 extracts a plurality of tracking candidate windows which belong to the target search range centered on the target frame. The confidence calculation unit 42 compares the image features of each tracking candidate window multiplied by the weights in the target search range Rt with the target model, and calculates the confidence of each tracking candidate window. Subsequently, the target frame estimation unit 41 determines the tracking candidate window with the highest confidence level among the tracking candidate windows, as the target frame in that image (step S32). Thus, the target tracking is performed.

Next, the target model update unit 43 updates the target model using the obtained target frame when the confidence level of the tracking result belongs to a predetermined value range (step S33). Accordingly, the target model is updated.

As described above, according to the first example embodiment, because the target search range is set using a template according to the movement pattern of the target, and the target search range is updated according to the movement direction and the movement amount of the target, it is possible to always track the target in the appropriate target search range. As a result, it is possible to prevent the occurrence of the passing over.

### Second Example Embodiment

Next, an object tracking device according to a second example embodiment will be described. The object tracking device 100 of the first example embodiment first determines the category of the target based on the input image and the position information of the target, and then derives the movement pattern of the target by referring to the category/movement pattern correspondence table. In contrast, the object tracking device of the second example embodiment differs from the first example embodiment in that the movement pattern of the target is directly determined based on the input image and the position information of the target. Other than this point, the object tracking device of the second example embodiment is basically the same as the object tracking device of the first example embodiment. In detail, an overall configuration and a hardware configuration of the object tracking device of the second example embodiment are the same as those of the first example embodiment illustrated in FIG. 1 and FIG. 2, and the explanations thereof will be omitted.

### [Functional Configuration]

The overall functional configuration of the object tracking device according to the second example embodiment is the same as that of the object tracking device 100 according to the first example embodiment illustrated in FIG. 3. However, the configuration of the preliminary training unit and the target model generation unit differ from those in the first example embodiment.

FIG. 15 illustrates the configuration of the preliminary training unit 20x of the object tracking device according to the second example embodiment. As can be seen by comparing with the preliminary training unit 20 of the first example embodiment illustrated in FIG. 4, the preliminary training unit 20x of the second example embodiment includes a movement pattern discriminator 23 instead of the category discriminator 22. The movement pattern discriminator 23 generates a movement pattern discrimination model which discriminates the movement pattern of the target in the input image. The movement pattern discriminator 23 is formed by, for instance, the CNN.

Specifically, the movement pattern discriminator 23 extracts image features of the target based on the input image and the position information indicating the position of the target in the input image, and determines the movement pattern of the target based on the image features of the target. In that case, different from the category discriminator 22 of the first example embodiment, the movement pattern discriminator 23 does not discriminate the category of the target. That is, the movement pattern discriminator 23 trains the correspondence between the image features and the movement pattern of the target, such as “the target with such image features moves in such the movement pattern”, and discriminates the movement pattern. As illustrated in FIG. 9, for instance, the movement pattern discrimination model is trained so as to estimate the movement pattern of the target with the image features similar to those of the person as the omni-directional type, to estimate the movement pattern of the target with the image features similar to those of the bicycle as the forward oriented type, and to estimate the movement pattern of the target with the image features similar to those of the car as the forward oriented type.

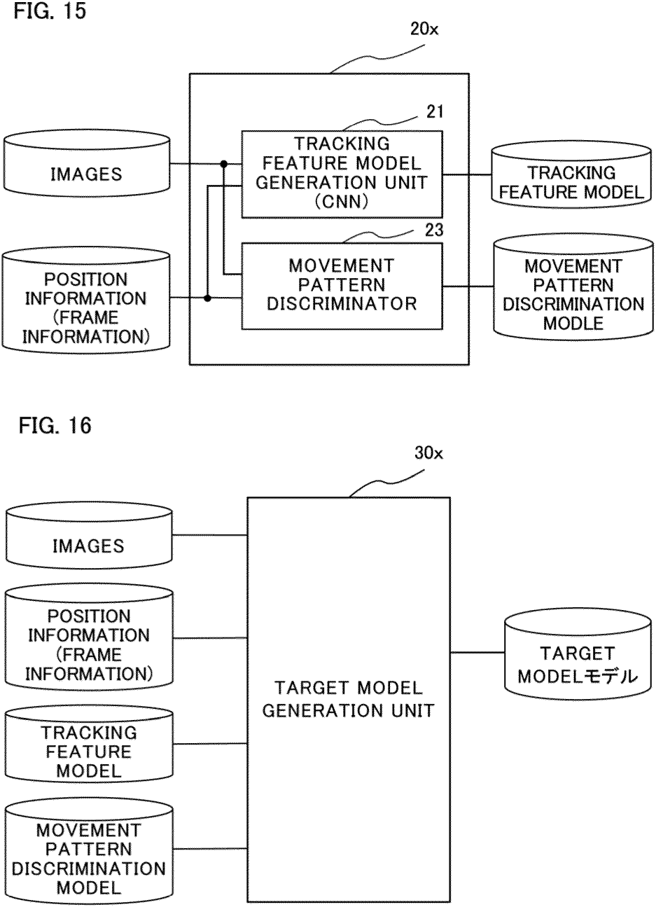

FIG. 16 illustrates a configuration of the target model generation unit 30x of the object tracking device in the second example embodiment. In the second example embodiment, the target model generation unit 30x determines the movement pattern of the target directly from the input image using the movement pattern discrimination model. Therefore, as can be seen by comparing with the configuration in FIG. 5, the target model generation unit 30x in the second example embodiment does not use the category/movement pattern correspondence table. Other than this point, the target model generation unit 30x is similar to the target model generation unit 30 of the first example embodiment.

### [Processing by the Object Tracking Device]

Next, each of processes performed by the object tracking device of the second example embodiment will be described. The object tracking device executes the preliminary training process, the target model generation process, and the tracking process.

### (Preliminary Training Process)

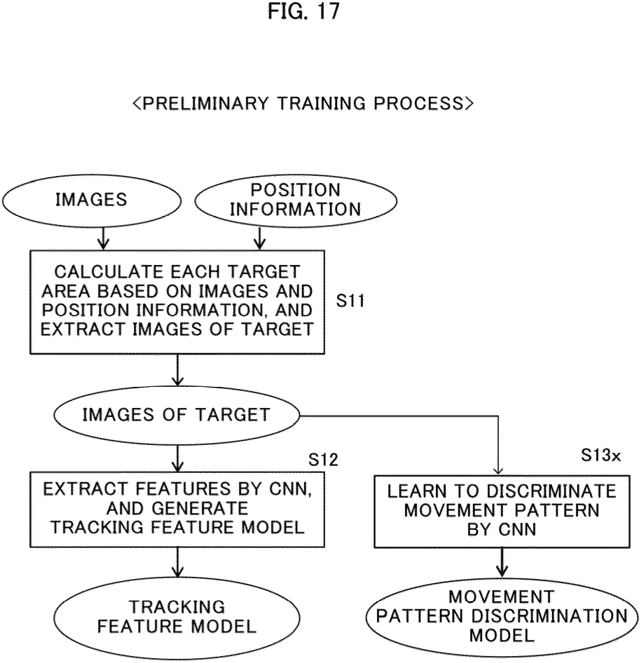

FIG. 17 is a flowchart of the preliminary training process in the second example embodiment. As can be seen by comparing with the flowchart in FIG. 11, steps S11 to S12 are similar to the preliminary training process of the first example embodiment, and the explanations thereof will be omitted. In the second example embodiment, the movement pattern discriminator 23 of the preliminary training unit 20 learns to discriminate the movement pattern of the target from the target image extracted in step S11 using the CNN, and generates the movement pattern discrimination model (step S13x). The preliminary training process is then terminated.

### (Target Model Generation Process)

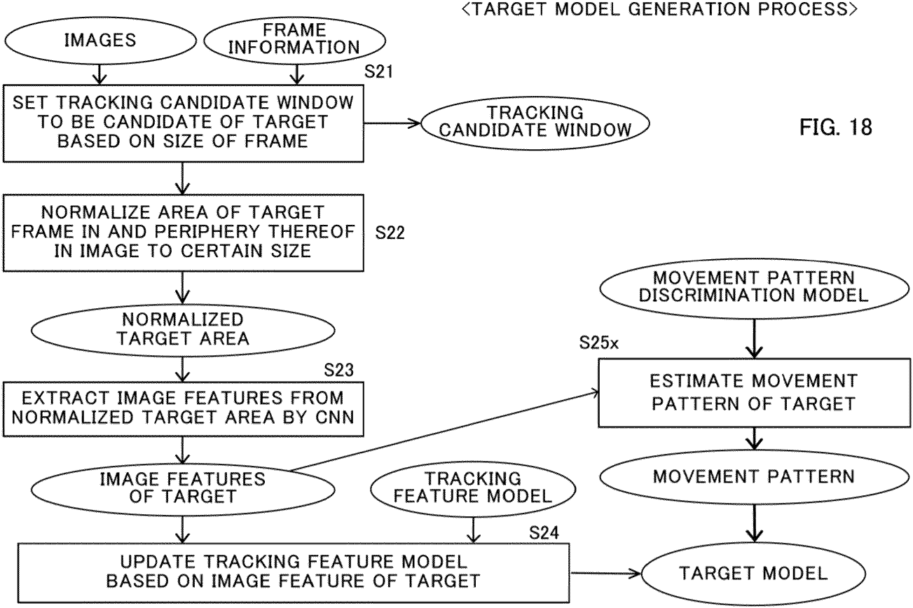

FIG. 18 is a flowchart of the target model generation process in the second example embodiment. As can be seen by comparing with the flowchart in FIG. 12, steps S21 to S24 are similar to the target model generation process in the first example embodiment, and the explanations thereof will be omitted. In the second example embodiment, the target model generation unit 30x uses the movement pattern discrimination model generated by the preliminary training unit 20x to estimate the movement pattern of the target from the target image features extracted in step S23 and to add the movement pattern to the target model (step S25x). The target model will thus include the movement pattern of the target. The target model generation process is then terminated.

### (Tracking Process)

In the tracking process, the target search range is updated using the movement pattern of the target model obtained by the target model generation process described above, and the target is tracked. Note that the tracking process itself is the same as in the first example embodiment, and the explanation thereof will be omitted.

As described above, in the second example embodiment, because the target search range is also set using the template according to the movement pattern of the target, and the target search range is updated according to the movement direction and the movement amount of the target, it is always possible to track the target in the appropriate target search range. As a result, it is possible to prevent the occurrence of the passing over.

### Third Example Embodiment

FIG. 19 is a block diagram illustrating a functional configuration of an object tracking device 50 for a third example embodiment. The object tracking device 50 includes an extraction means 51, a search range update means 52, a tracking means 53, and a model update means 54. The extraction means 51 extracts target candidates from time series images. The search range update means 52 updates the search range based on the frame information of the target in the previous image in the time series and the movement pattern of the target. The tracking means 53 searches for and tracks the target from the target candidates extracted within the search range using the confidence level indicating the similarity with the target model. The model update means 54 updates the target model using the target candidates extracted within the search range.

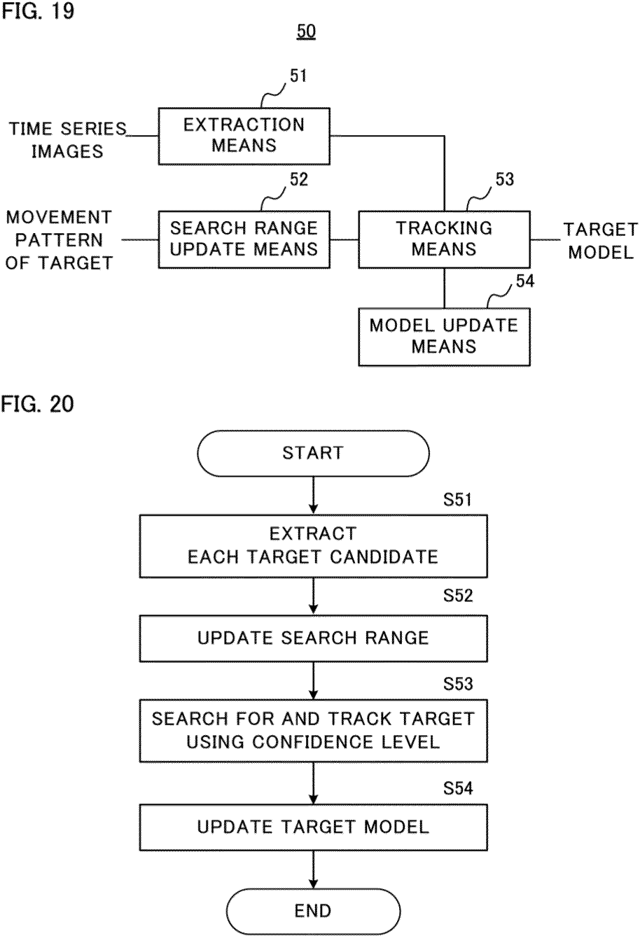

FIG. 20 is a flowchart of the object tracking process according to the third example embodiment. The extraction means 51 extracts each target candidate from the time series images (step S51). The search range update means 52 updates the search range based on the frame information of the target in the previous image in the time series and the movement pattern of the target (step S52). The tracking means 53 searches for and tracks the target from the target candidates extracted within the search range using the confidence level indicating the similarity with the target model (step S53). The model update means 54 updates the target model using the target candidates extracted within the search range (step S54).

According to the object tracking device of the third example embodiment, since the target search range is set based on the movement pattern of the target, it is always possible to track the target in the appropriate target search range.

A part or all of the example embodiments described above may also be described as the following supplementary notes, but not limited thereto.

### (Supplementary Note 1)

An object tracking device comprising:
an extraction means configured to extract target candidates from time series images;
a search range update means configured to update a search range based on frame information of a target in a previous image in a time series and a movement pattern of the target;
a tracking means configured to search for and track the target using a confidence level indicating similarity with a target model among the target candidates extracted in the search range; and
a model update means configured to update the target model using the target candidates extracted in the search range.

### (Supplementary Note 2)

The object tracking device according to supplementary note 1, further comprising
a category discrimination means configured to discriminate a category of the target in the time series images; and
a movement pattern determination means configured to acquire a movement pattern corresponding to the category by using correspondence information of categories and movement patterns, and set the acquired movement pattern as a movement pattern of the target.

### (Supplementary Note 3)

The object tracking device according to supplementary note 1, further comprising a movement pattern discrimination means configured to determine the movement pattern of the target based on the time series images.

### (Supplementary Note 4)

The object tracking device according to any one of supplementary notes 1 to 3, wherein the search range update means sets a template corresponding to the movement pattern as the search range.

### (Supplementary Note 5)

The object tracking device according to supplementary note 4, wherein the search range update means rotates the search range so as to correspond to a movement direction of the target.

### (Supplementary Note 6)

The object tracking device according to supplementary note 4 or 5, wherein the search range update means extends the search range in a movement direction of the target.

### (Supplementary Note 7)

The object tracking device according to supplementary note 6, wherein the search range update means contracts the search range in a direction orthogonal to the movement direction of the target.

### (Supplementary Note 8)

The object tracking device according to any one of supplementary notes 4 to 7, wherein
the template includes weights of respective positions in an area of the template, and
the search range update means moves a center of the weights in the search range based on a movement amount of the target.

### (Supplementary Note 9)

The object tracking device according to supplementary note 8, wherein the tracking means calculates the confidence level between the image features of the candidate target multiplied by the weights in the search range and the target model.

### (Supplementary Note 10)

An object tracking method comprising:
extracting target candidates from time series images;
updating a search range based on frame information of a target in a previous image in a time series and a movement pattern of the target;
searching for and tracking the target using a confidence level indicating similarity with a target model among the target candidates extracted in the search range; and
updating the target model using the target candidates extracted in the search range.

### (Supplementary Note 11)

A recording medium storing a program, the program causing a computer to perform a process comprising:
extracting target candidates from time series images;
updating a search range based on frame information of a target in a previous image in a time series and a movement pattern of the target;
searching for and tracking the target using a confidence level indicating similarity with a target model among the target candidates extracted in the search range; and
updating the target model using the target candidates extracted in the search range.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

DESCRIPTION OF SYMBOLS

| | |
|---|---|
| 11 | Input IF |
| 12 | Processor |
| 13 | Memory |
| 14 | Recording medium |
| 15 | Database |
| 16 | Input device |
| 17 | Display device |
| 20 | Preliminary training unit |
| 30 | Target model generation unit |
| 40 | Tracking unit |
| 41 | Target frame estimation unit |
| 42 | Confidence level calculation unit |
| 43 | Target model update unit |
| 100 | Object tracking device |
| Rt | Target search range |

What is claimed is:

1. An object tracking device comprising:
a memory storing instructions; and
one or more processors configured to execute the instructions to:
extract target candidates from time series images;
update a search range based on frame information of a target in a previous image in a time series and a movement pattern of the target;
search for and track the target using a confidence level indicating similarity with a target model among the target candidates extracted in the search range; and
update the target model using the target candidates extracted in the search range.

2. The object tracking device according to claim 1, wherein the processor is further configured to
discriminate a category of the target in the time series images; and
acquire a movement pattern corresponding to the category by using correspondence information of categories and movement patterns, and set the acquired movement pattern as a movement pattern of the target.

3. The object tracking device according to claim 1, wherein the processor is further configured to determine the movement pattern of the target based on the time series images.

4. The object tracking device according to claim 1, wherein the processor sets a template corresponding to the movement pattern as the search range.

5. The object tracking device according to claim 4, wherein the processor rotates the search range so as to correspond to a movement direction of the target.

6. The object tracking device according to claim 4, wherein the processor extends the search range in a movement direction of the target.

7. The object tracking device according to claim 6, wherein the processor contracts the search range in a direction orthogonal to the movement direction of the target.

8. The object tracking device according to claim 4, wherein
the template includes weights of respective positions in an area of the template, and
the processor moves a center of the weights in the search range based on a movement amount of the target.

9. The object tracking device according to claim 8, wherein the processor calculates the confidence level between the image features of the candidate target multiplied by the weights in the search range and the target model.

10. An object tracking method comprising:
extracting target candidates from time series images;
updating a search range based on frame information of a target in a previous image in a time series and a movement pattern of the target;
searching for and tracking the target using a confidence level indicating similarity with a target model among the target candidates extracted in the search range; and
updating the target model using the target candidates extracted in the search range.

11. A non-transitory computer-readable recording medium storing a program, the program causing a computer to perform a process comprising:
extracting target candidates from time series images;
updating a search range based on frame information of a target in a previous image in a time series and a movement pattern of the target;
searching for and tracking the target using a confidence level indicating similarity with a target model among the target candidates extracted in the search range; and
updating the target model using the target candidates extracted in the search range.
